(19) United States
(12) Patent Application Publication
(10) Pub. No.: US 2020/0102981 A1
(43) Pub. Date: Apr. 2, 2020

(54) Nut With Clinching Lugs

(71) Applicant: Penn Engineering & Manufacturing, Corp., Danboro, PA (US)

(72) Inventor: Jacques Abboud, Pipersville, PA (US)

(21) Appl. No.: 16/589,252

(22) Filed: Oct. 1, 2019

Related U.S. Application Data
(60) Provisional application No. 62/740,389, filed on Oct. 2, 2018.

(51) Int. Cl. F16B 37/06

(52) U.S. Cl. CPC F16B 37/068

(57) ABSTRACT

A clinch nut has a flange with additional clinch features. The nut construction includes rectangular torque-lugs radially spanning the bottom surface of the nut flange. Each lug has a displacer and an undercut. When assembled to a panel the mating panel has a star-shaped hole comprised of a central round mounting hole in addition to a number of apertures/openings that are aligned with the lugs of the nut. In one embodiment a hexagonal nut with six side flats has a flange with six torque lugs underneath the nut flange which are pointed orthogonally to the nut flats. This construction is employed in conjunction with a receiving panel or plate having a central circular opening surrounded by apertures in alignment with the nut lugs. Both the nut shank and each of the lugs clinch into the panel.

### RELATED APPLICATION

This is a non-provisional patent application related to provisional patent application entitled, Nut with Clinching Lugs, Ser. No. 62/740,389 filed on Oct. 2, 2018 priority from which is hereby claimed.

### FIELD OF THE INVENTION

The present invention relates to metal fasteners, in particular female threaded fasteners which attach to a host object such as a flat panel by the deformation of the panel material. More specifically it relates to nuts which clinch into a hole in a receiving panel whereby features of the nut when pressed into the panel cause material of the panel to cold flow into undercuts of the nut.

### BACKGROUND OF THE INVENTION

Clinch nuts and mainly their clinching features come in different shapes and forms. What they all have in common, however, is the fact that push-out resistance features are totally independent (and sometimes separate) from their torque-out resistance.

Features which affect “push-out” mainly consist of a round shank, a round undercut, and a round displacer. When the displacer engages with the mating panel, it displaces the panel material into the nut round undercut preventing it from being pushed out of the panel. On the other hand, “torque-out” features are mainly represented by knurls or lugs that once engaged with the mating panel, prevent the nut from spinning in place. The resultant nut resistance to push-out and torque-out is limited with clinching nuts since this type of nut only engage one side of the panel, making them poor performers compared to their rival substitute, rivet nuts. One way to increase the clinching nut's performance is to increase the mating panel thickness. It's not always an option and not always desirable since it makes the joint heavier. The main advantage of using clinch nuts over rivet nuts remains in the fact that they allow a full contact between fact-to-face mating panels while sacrificing some performance.

Rivet nuts (self-piercing and non-self-piercing) well known in the art usually offer the highest torque-out and push-out performance because of the way they engage the mating panel. After engagement, both sides of the panel are aggressively held by the nut body and shank, and torque-out resistance is ensured by the presence of nut lugs spread around the shank, digging into the panel and preventing circular motion of the nut. There are no features on the lugs to resist pull out force since none is needed. In rivet nuts however and unlike clinch nuts, both sides of the panel need to be accessible to the mating nut. This prevents a full contact between two panels being assembled together face-to-face since the flared shank of the rivet nut interferes with the second panel.

Thus, both clinch nuts and rivet nuts each have their advantages and disadvantages. One of their shared characteristics is that they both represent cold joints. Other types of attachments such as weld nuts could provide an even better performance in push-out and torque-out than rivet or clinch nuts however they require heat which might not be feasible for some applications and is not as clean and “green” compared to that of clinch or rivet nuts.

There is therefore a need in the fastening art for a nut which combines the performance and installation advantages of both Rivet-type and clinch-type nuts.

### SUMMARY OF THE INVENTION

In order to meet the need in the art described above the present clinch nut has been devised. The present invention is an orientable self-clinching nut offering higher performance than comparative clinch nuts in resisting torque-out and push-out. The nut construction includes rectangular torque-lugs radially spanning the bottom surface of the nut flange. The mating panel has a star-shaped hole, comprised of a round mounting hole in addition to a number of apertures/openings that are aligned with the lugs of the nut and the number of flats present on the nut flange. In one embodiment of the invention described herein a hexagonal nut flange has six torque lugs underneath the nut flange which are pointed orthogonally to the nut flats. This construction is employed in conjunction with a receiving panel or plate having a central circular opening surrounded by apertures in alignment with the nut lugs.

More specifically, in one embodiment of the invention the applicant has devised a clinch nut comprising a flange having a plurality of lugs extending downward from its bottom surface. A nut upward shank and a downward shank share a central vertical axis and each extends from and is integral with the flange. Both shanks have a circular cross-section. The nut is constructed such that each of the lugs comprises a shank, a displacer and an undercut adapted to receive the cold flow of material from a panel to which the clinch nut is attached. The nut is internally threaded, and the flange is hexagonal with six flat sides with each lug adjacent the center of one of flat sides of the flange. The downward shank has a circular displacer and a circular undercut, said displacer and said undercut being equal in length to the lug displacers and lug undercuts respectively. Each of the lugs has a rectangular lateral profile aligned radially with the axis of the nut. A cross-section of one torque lug along its width reveals a quasi-hour-glass shape, providing on its two lateral sides the necessary undercuts to resist push-out force. In other words, the lugs' undercuts represent an additional dwelling place for the displaced mating panel/plate material, when the nut is also clinched in by the central undercut directly beneath the nut bore that also engages the panel.

The nut of the invention can be assembled to a panel or plate having an irregular receiving aperture defined by a central circular portion and a plurality of radial notches which radiate from the circular portion. The circular portion is dimensioned to accept the downward nut shank and each of the notches is positioned and dimensioned to accept each of the lugs such that when pressed together material of the plate flows into the undercuts of the downward shank and the lugs.

To the best of the applicant's knowledge, there is not a clinching nut equipped with torque-lugs, where those lugs are also the source of the nut resistance to being pushed out of the mating panel. This novelty of the present clinch nut offers a much higher performance than a conventional clinch nut comparable to a rivet nut with the advantage that only one side of a mating panel need be accessed and while only requiring a low installation force.

Thus, it is the object of the invention to provide a clinch nut with enhanced push-out and torque-out performance. This and other objects and advantages of the inventive clinch nut will be apparent to those of skill in the art from the following figures of drawing and description of one embodiment thereof.

### BRIEF DESCRIPTION OF THE DRAWINGS

FIG. 1 is a top right front isometric view.

FIG. 2 is a front elevation sectional view.

FIG. 3 is a bottom plan view.

FIG. 4B is a compound illustration showing an elevation sectional view and where the view was taken from the view depicted in FIG. 4A.

FIG. 5 is a cross-sectional view of a fastener lug shown in isolation.

FIG. 6 is a top right isometric view of a panel with a hole for receiving the fastener of FIGS. 1-3.

FIG. 7 is a top plan view of the fastener of FIGS. 1-3 installed into the panel of FIG. 6.

FIG. 8 is a front elevation sectional view taken from FIG. 6 as shown in that Figure.

FIG. 9 is a bottom plan view of the fastener assembly of FIG. 7.

FIGS. 10 and 11 are sectional views taken along the line shown in FIG. 9 which depict before and after installation positions of the fastener and panel.

### DESCRIPTION OF THE PREFERRED EMBODIMENT

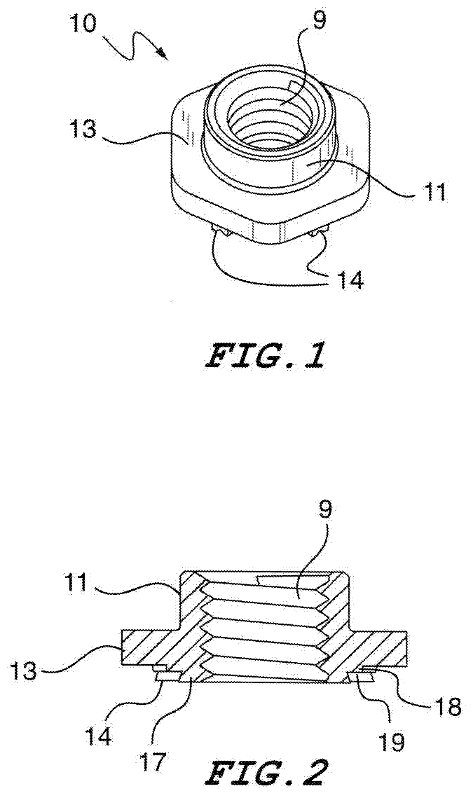

Referring now to FIG. 1, the main features of the present fastener, nut 10 as seen from above are a circular upward extending top shank 11 with threads 9 and being integral with a hexagonal flange 13. A plurality of lugs 14 are equally spaced about the bottom of the flange 13 and are radial extensions of a downward extending bottom shank 17 as seen in FIG. 2. The hexagonal shape of the flange is chosen to minimize weight, but other shapes are possible as are other numbers of lugs.

Referring now to FIG. 2 we see from this sectional view greater details of this embodiment of the invention. Here we see that the nut has threads 9 that extend through its entire length. Described from top to bottom, the nut has a top shank 11, flange 13, and a circular displacer 18 on bottom shank 17 which includes an undercut 19 that follows underneath all portions of the displacer 18. Lugs 14 extend to the same longitudinal length from the flange 13 as the shank 17. The displacer 18 is described as “circular” because it is circular in part about the shank. Other portions of the displacer comprise straight radial segments on the lugs as seen in more detail in the figures or drawing which follow.

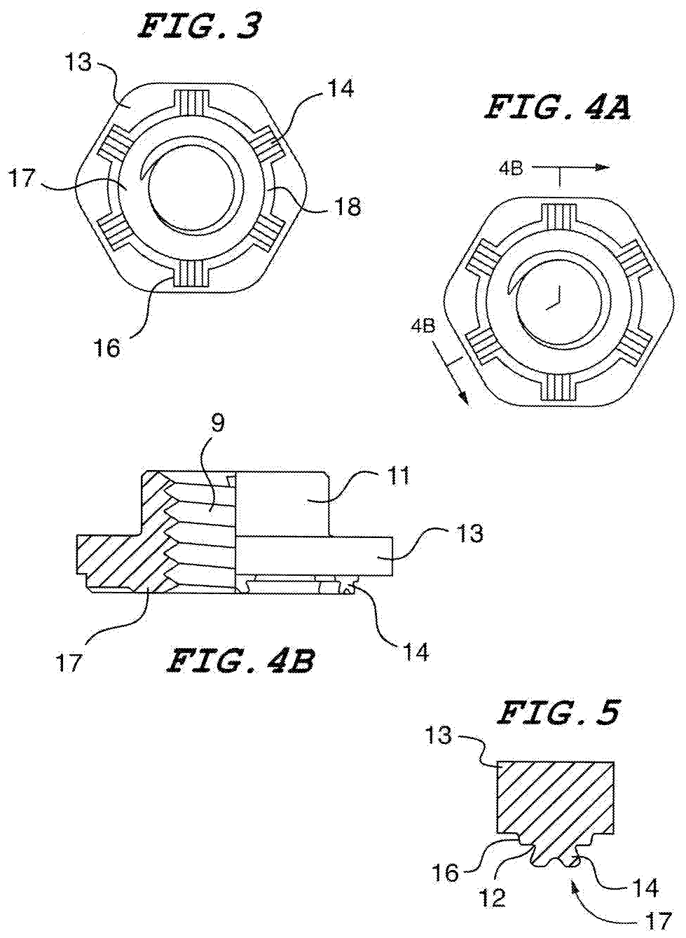

Referring now to FIG. 3 we see a plan view from the bottom which shows six lugs 14 on the flange 13. Here we also see the displacer extending radially from the shank 17 and having a circular shank portion 18 and a lug displacer portion 16. Both portions of the displacer extend the same axial distance from the flange 13.

Referring now to FIGS. 4A and 4B, a compound sectional view (4B) taken from FIG. 4A shows the longitudinal relationship between the lugs 14 and the shank 17 and their relationship to the top shank 11, flange 13 and the internal through bore with threads 9.

In FIG. 5 we see a close-up view of the displacer portion 16 above lug 14 which extends downward from the flange 13. The lugs 14 are radial extensions of the shank 17 and each lug has an undercut 12 directly below its displacer portion 16.

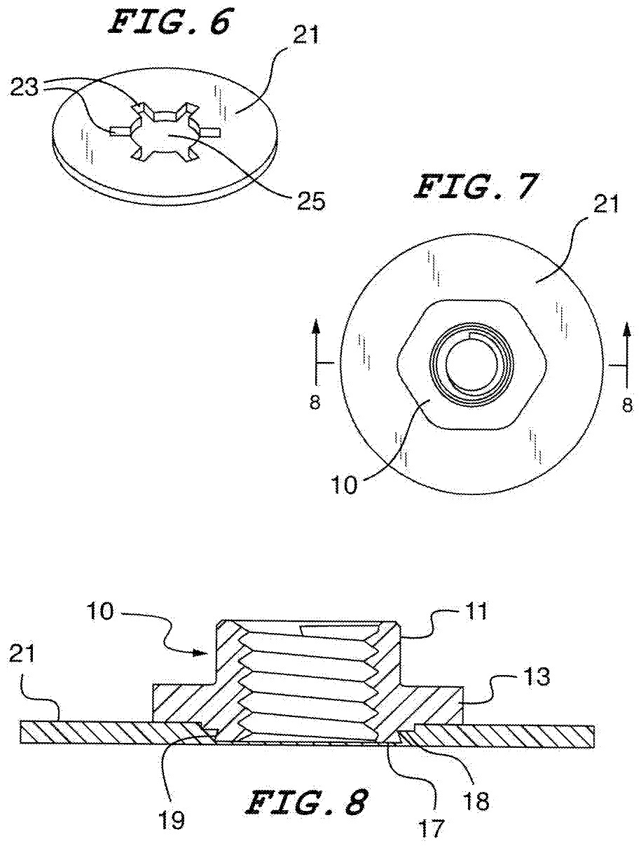

In FIG. 6 we see a plate 21 which is compatible with the clinch nut of FIGS. 1-3. For convenience of illustration the plate 21 is shown as circular but could be any shape. The plate 21 has an irregular hole with a central circular portion 25 and a plurality of radial notches 23 which emanate from the circular portion 25. The circular portion is dimensioned to accept the shank of the nut 10 as seen in FIG. 8 below while each of the notches is positioned and dimensioned to accept the lugs as seen in FIG. 10 below.

Referring now to FIGS. 7 and 8, the nut 10 is shown installed into plate 21. The sectional view seen in FIG. 8 is taken from a diameter of the nut through its opposite corners as shown in FIG. 7 and thus the clinch features of the circular shank and not those of the lugs are seen here. Those features can be viewed from the following FIGS. 10 and 11. In FIG. 8 we see that material of the plate 21 has flowed around the shank 17 and into its undercuts 19 by deformation of the plate by the displacer 18.

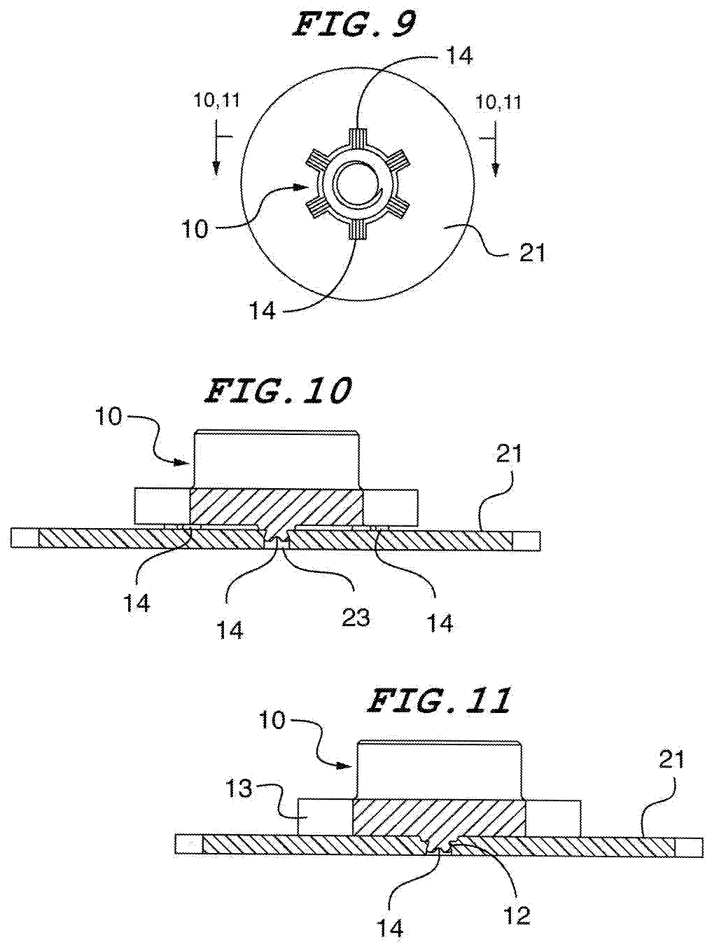

In FIGS. 9 through 11 we see the interaction of the clinch lugs 14 with the receiving plate 21. As indicated by FIG. 9 the sectional views of FIGS. 10 and 11 show an elevation sectional view of a representative lug 14 from a perspective looking radially inward.

FIG. 10 shows the starting position of the nut 10 and plate 21 prior to installation. Here, lug 14 as well as the other lugs 14 are partially received in their respective notches until their displacers and the shank displacer contacts the top of the plate.

In FIG. 11 we see the ending point of the installation by pressing begun in FIG. 10. By a downward pressing force applied to the nut 10, material of the plate 21 has flowed into the undercuts 12 of the lugs 14. Simultaneously material of the plate has flowed into the circular shank undercut not seen here but as seen above in FIG. 8. The installation is completed when the flange 13 bottoms out against the plate 21. At this point the lugs occupy the full width of the plate.

From the foregoing description of one embodiment of the invention it will be apparent to those of skill in the art that the object of the invention has been achieved The force of attachment is enhanced compared to prior art clinch nuts of the same thread diameter in two ways. First, torque-out resistance is greatly increased by the embedded lugs which extend deeply into the receiving plate its full thickness. Secondly, the sides of the lugs provide additional undercut area which can receive more of the plate material which increases pull-out resistance. Other objects and advantages may be recognized by those of skill in the art. The invention is to be limited only by the following claims and their legal equivalents.

What is claimed is:

1. A clinch nut, comprising:
a flange having a plurality of lugs extending downward from its bottom surface;
a nut top shank having a central vertical axis and extending upwardly from and integral with the flange; and
wherein each of the lugs comprises a shank, a displacer and an undercut adapted to receive the cold flow of material from a plate by which the clinch nut is attached to the plate.

2. The nut of claim 1 wherein the nut is internally threaded.

3. The nut of claim 1 wherein the flange is hexagonal with six flat sides.

4. The nut of claim 3 wherein there are six lugs, each lug adjacent the center of one of flat sides of the flange.

5. The nut of claim 2 wherein the nut shanks have a circular cross-section.

6. The nut of claim 1 wherein each of the lug displacers is equal in length.

7. The nut of claim 6 further including a second circular bottom shank extending downwardly from the flange, said bottom shank having a circular displacer and a circular undercut, said displacer and said undercut being equal in length to the lug displacers and lug undercuts respectively.

8. The nut of claim 4 wherein each of the lugs has a rectangular lateral profile aligned radially with the axis of the nut.

9. An assembly of the nut of claim 7 to a plate, comprising:
a plate having an irregular receiving aperture defined by a central circular portion and a plurality of radial notches which radiate from the circular portion; and
wherein the circular portion is dimensioned to accept the bottom nut shank and each of the notches is positioned and dimensioned to accept each of the lugs such that when pressed together material of the plate flows into the undercuts of the bottom shank and the lugs.

10. The assembly of claim 9 wherein each of the lugs has a rectangular lateral profile with parallel sides aligned radially with the axis of the nut.
